(19) United States
(12) Patent Application Publication
(10) Pub. No.: US 2026/0150048 A1
(43) Pub. Date: May 28, 2026

(54) METHOD AND DEVICE FOR TRANSMITTING INDICATION INFORMATION

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 19/120,598

(22) PCT Filed: Oct. 14, 2022
(86) PCT No.: PCT/CN2022/125505

§ 371 Date: Apr. 11, 2025

(51) Int. Cl. H04W 52/02

(52) U.S. Cl. CPC H04W 52/0235

(57) ABSTRACT

The present disclosure provides a method for sending indication information, which is performed by a network device, and includes: sending the indication information to a user equipment (UE), wherein the indication information is configured to indicate UE behavior(s) of the UE after being woken up.

### CROSS-REFERENCE TO RELATED APPLICATIONS

The present application is a U.S. National Stage of International Application No. PCT/CN2022/125505 filed on Oct. 14, 2022, the entire contents of which are incorporated herein by reference for all purposes.

### TECHNICAL FIELD

The present disclosure relates to the field of wireless communication technology, and in particular, to a method and device for transmitting indication information and a readable storage medium.

### BACKGROUND

The Low Power Wake Up Signal (LP WUS) was introduced in Release 18(R18 ) of the 3rd Generation Partnership Project (3GPP). A base station sends LP WUS to a User Equipment (UE) to wake up the UE. The UE may monitor and receive the LP WUS using a separate low-power receiver, and after receiving the LP WUS, wake up a main receiver to send and receive data, thereby realizing energy saving of the UE.

### SUMMARY

The present disclosure provides a method and device for transmitting indication information and a readable storage medium.

A first aspect of the present disclosure provides a method for sending indication information, being performed by a network device, and including:
sending the indication information to a user equipment (UE), wherein the indication information is configured to indicate UE behavior(s) of the UE after being woken up.

In some possible implementations, sending the indication information to the UE includes:
sending a low power wake up signal (LP WUS) to the UE, wherein the LP WUS includes the indication information.

In some possible implementations, sending the indication information to the UE includes:
sending an LP WUS to the UE, wherein a frequency domain location or a time domain location of the LP WUS corresponds to the indication information.

In some possible implementations, sending the indication information to the UE includes:
sending an LP WUS to the UE, wherein a cyclic shift value of the LP WUS corresponds to the indication information.

In some possible implementations, the UE behavior(s) includes one of:
monitoring a paging message;
monitoring system information;
performing a mobility measurement; or
performing a cell reselection.

In some possible implementations, the system information includes one of:
system information related to resource configuration of the LP WUS; or
system information related to resource configuration of the paging message.

In some possible implementations, the system information related to the resource configuration of the LP WUS includes at least one of:
a first type of system information; or
a second type of system information;
wherein the first type of system information includes an updated time domain resource configuration and/or an updated frequency domain resource configuration of the LP WUS, and the second type of system information includes an updated power configuration of the LP WUS.

In some possible implementations, the system information related to the resource configuration of the paging message includes:
a third type of system information including an updated resource configuration of the paging message.

A second aspect of the present disclosure provides a method for receiving indication information, being performed by a user equipment (UE), and including:
receiving the indication information sent by a network device, wherein the indication information is configured to indicate UE behavior(s) of the UE after being woken up.

In some possible implementations, receiving the indication information sent by the network device includes:
receiving a low power wake up signal (LP WUS) sent by the network device, wherein the LP WUS includes the indication information.

In some possible implementations, receiving the indication information sent by the network device includes:
receiving an LP WUS sent by the network device; and
determining the indication information based on a frequency domain location or a time domain location of the LP WUS.

In some possible implementations, receiving the indication information sent by the network device includes:
receiving an LP WUS sent by the network device; and
determining the indication information based on a cyclic shift value of the LP WUS.

In some possible implementations, the UE behavior(s) includes one of:
monitoring a paging message;
monitoring system information;
performing a mobility measurement; or
performing a cell reselection.

In some possible implementations, the method further includes:
switching from a sleeping state to a working state after receiving the LP WUS, and performing corresponding UE behavior(s) based on the indication information.

In some possible implementations, performing the corresponding UE behavior(s) based on the indication information includes:
receiving a first type of system information or a second type of system information when the indication information corresponds to monitoring of system information related to resource configuration of the LP WUS; and
according to the first type of system information or the second type of system information, monitoring the LP WUS based on an updated resource configuration of the LP WUS.

In some possible implementations, performing the corresponding UE behavior(s) based on the indication information includes:
receiving a third type of system information when the indication information corresponds to monitoring of system information related to resource configuration of the paging message;
according to the third type of system information, monitoring the paging message based on an updated resource configuration of the paging message.

A third aspect of the present disclosure provides a device for sending indication information, which can be configured to perform the steps executed by the network device in the above first aspect or any possible design thereof. The network device can implement various functions in each of the above methods in the form of a hardware structure, a software module or a combination of hardware structure and soft module.

When the device according to the third aspect is implemented with the software module, the device may include a transceiver module which may be configured to support communication of a communication device.

When executing the steps in the above first aspect, the transceiver module is configured to send the indication information to a user equipment (UE), wherein the indication information is configured to indicate UE behavior(s) of the UE after being woken up.

A fourth aspect of the present disclosure provides a device for receiving indication information, which can be configured to perform the steps executed by the user equipment in the above second aspect or any possible design thereof. The user equipment can implement various functions in each of the above methods in the form of a hardware structure, a software module or a combination of hardware structure and soft module.

When the device according to the fourth aspect is implemented with the software module, the device may include a transceiver module which may be configured to support communication of a communication device.

When executing the steps in the above second aspect, the transceiver module is configured to receive the indication information sent by a network device, wherein the indication information is configured to indicate UE behavior(s) of the UE after being woken up.

A fifth aspect of the present disclosure provides a communication device including a processor and a memory, the memory stores a computer program, and the processor is configured to execute the computer program to implement the first aspect or any possible design thereof.

A sixth aspect of the present disclosure provides a communication device including a processor and a memory, the memory stores a computer program, and the processor is configured to execute the computer program to implement the second aspect or any possible design thereof.

A seventh aspect of the present disclosure provides a computer-readable storage medium having instructions (or a computer program or a program) stored thereon that, when being invoked and executed on a computer, cause the computer to implement the first aspect or any possible design thereof.

An eighth aspect of the present disclosure provides a computer-readable storage medium having instructions (or a computer program or a program) stored thereon that, when being invoked and executed on a computer, cause the computer to implement the second aspect or any possible design thereof.

It is to be understood that the above general description and the detailed descriptions that follow are exemplary and explanatory only and do not limit the present disclosure.

### BRIEF DESCRIPTION OF THE DRAWINGS

The accompanying drawings illustrated herein are used to provide a further understanding of embodiments of the present disclosure and form a part of the present disclosure, and the exemplary embodiments of the present disclosure and their illustrations are used to explain the embodiments of the present disclosure and do not constitute an undue limitation of the embodiments of the present disclosure.

The accompanying drawings herein, which are incorporated into and form a part of the specification, illustrate embodiments consistent with the embodiments of the present disclosure and are used together with the specification to explain the principle of the embodiments of the present disclosure.

FIG. 1 is a schematic diagram of a wireless communication system architecture provided by an embodiment of the present disclosure;

FIG. 2 is a flowchart of a method for transmitting indication information according to an exemplary embodiment;

FIG. 3 is a flowchart of another method for transmitting indication information according to an exemplary embodiment;

FIG. 4 is a flowchart of a method for sending indication information according to an exemplary embodiment;

FIG. 5 is a flowchart of a method for receiving indication information according to an exemplary embodiment;

FIG. 6 is a flowchart of another method for receiving indication information according to an exemplary embodiment;

FIG. 7 is a block diagram of a device for sending indication information according to an exemplary embodiment;

FIG. 8 is a block diagram of a communication device according to an exemplary embodiment;

FIG. 9 is a block diagram of a device for receiving indication information according to an exemplary embodiment; and

FIG. 10 is a block diagram of a user equipment according to an exemplary embodiment.

### DETAILED DESCRIPTION

Embodiments of the present disclosure are further described in conjunction with the accompanying drawings and detailed implementations.

Embodiments will be described herein in detail, examples of which are represented in the accompanying drawings. When the following description relates to the accompanying drawings, the same numerals in the different figures indicate the same or similar elements unless otherwise indicated. The implementations described in the following embodiments do not represent all implementations consistent with the embodiments of the present disclosure. Rather, they are only examples of devices and methods consistent with some aspects of the present disclosure as detailed in the attached claims.

The term used in the embodiments of the present disclosure is used solely for describing particular embodiments and is not intended to limit the embodiments of the present disclosure. The singular forms of “a”, “an”, “said” and “the” used in the embodiments of the present disclosure and the appending claims are also intended to encompass the plural forms, unless clearly indicated otherwise in the context. It is to be also understood that the term “and/or” as used herein refers to and encompasses any or all possible combinations of one or more of the associated listed items.

It is to be understood that while the terms first, second, third, etc. may be used in the embodiments of the present disclosure to describe various information, such information should not be limited to these terms. These terms are only used to distinguish the same type of information from one another. For example, without departing from the scope of the embodiments of the present disclosure, first information may also be referred to as second information, and similarly, the second information may be referred to as the first information. Depending on the context, the word “if” as used herein may be interpreted as “at the time of . . . ” or “when . . . ” or “in response to determining”.

Embodiments of the present disclosure will be described in details below, examples of which are shown in the accompanying drawings, and throughout which, the same or similar numerals indicate the same or similar elements. The embodiments described below with reference to the accompanying drawings are exemplary and are intended to explain the present disclosure but not to be construed as a limitation of the present disclosure.

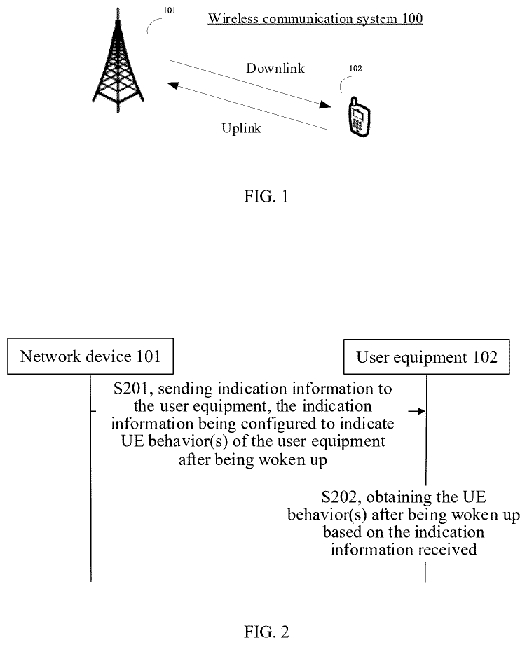

As shown in FIG. 1, a method for transmitting indication information provided by embodiments of the present disclosure may be applied to a wireless communication system 100, which may include a network device 101 and a user equipment 102. The user equipment 102 is configured to support carrier aggregation, and may be connected to a plurality of carrier units of the network device 101, including a primary carrier unit and one or more secondary carrier units.

It is to be understood that the above wireless communication system 100 may be applicable to both a low frequency scenario and a high frequency scenario. The application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system or the like.

The user equipment 102 shown above may be a terminal, an access terminal, a terminal unit, a terminal station, a mobile station (MS), a remote station, a remote terminal, a mobile terminal, a wireless communication device, a terminal agent, a terminal device or the like. The user equipment 102 may have a wireless transceiver function, which can communicate (e.g., wirelessly) with one or more network devices 101 of one or more communication systems and receive network services provided by the network devices. The network device herein includes, but is not limited to, the network device 101 as shown.

The user equipment 102 may be a cellular telephone, a cordless telephone, a session initiation protocol (SIP) telephone, a wireless local loop (WLL) station, a personal digital assistant (PDA) device, a handheld device with a wireless communication function, a computing device or other processing device connected to a wireless modem, an in-vehicle device, a wearable device, a terminal device in a future 5G network, a terminal device in a future evolved PLMN network, and the like.

The network device 101 may be an access network device (or access network site). The access network device refers to a device having a network access function, such as a radio access network (RAN) base station and the like. The network device 101 may specifically include a base station (BS), or include a base station and a wireless resource management device for controlling the base station, and the like. The network device 101 may further include a relay station (relay device), an access point, and a base station in future 5G network, a base station in future evolved PLMN network, a NR base station, or the like. The network device 101 may be a wearable device or an in-vehicle device. The network device 101 may also be a communication chip having a communication module.

For example, the network device 101 includes, but is not limited to, a next-generation base station (gnodeB, gNB) in 5G, an evolved node B (eNB) in an LTE system, a radio network controller (RNC), a node B (NB) in a WCDMA system, a wireless controller in a CRAN system, a base station controller (BSC), a base transceiver station (BTS) in a GSM system or a CDMA system, a home base station (e.g., home evolved nodeB, or home node B (HNB)), a baseband unit (BBU), a transmitting and receiving point (TRP), a transmitting point (TP), a mobile switching center or the like.

The network device 101 may send LP WUS due to different reasons to wake up the user equipment 102. However, the user equipment 102 may be unaware of the reason for being woken up, which may result in the user equipment 102 not making a response timely because of being unaware of the demand of the network device 101 after the user equipment 102 is woken up.

An embodiment of the present disclosure provides a method for transmitting indication information. FIG. 2 shows a method for transmitting indication information according to an embodiment, and as shown in FIG. 2, the method includes steps S201˜S202, specifically:
in step S201, the network device 101 sends the indication information to the user equipment (UE) 102, the indication information being configured to indicate UE behavior(s) of the UE after being woken up; and
in step S202, the UE 102 obtains the UE behavior(s) after being woken up based on the received indication information.

In some possible implementations, the network device 101 may wake up the UE 102 by sending an LP WUS.

In some possible implementations, before the UE 102 receives the LP WUS, a main receiver of the UE 102 is in a sleeping state, and the UE 102 employs a separate low-power receiver to monitor and receive the LP WUS. When the UE 102 receives the LP WUS, the main receiver of the UE 102 is woken up and enters into a working state, and the UE behavior(s) indicated by the indication information is performed.

The waking up of the UE 102 means that the main receiver of the UE 102 is switched from the sleeping state to the working state to perform operations such as sending and receiving of data.

In some possible implementations, the indication information may be sent separately via signaling other than the LP WUS. For example, the network device 101 sends Downlink Control Information (DCI) carrying the indication information to the UE 102.

In some possible implementations, the indication information is sent via the LP WUS. For example, the network device 101 sends the LP WUS carrying the indication information to the UE 102.

In some possible implementations, the network device 101 indicates the UE behavior(s) through the indication information, that is, the indication information may also indicate the reason why the network device 101 wakes up the UE 102. Therefore, the UE 102, upon receiving the indication information, may timely obtain the UE behavior(s) or the reason for waking up indicated by the network device 101, so that the UE may timely perform the relevant operation.

In the embodiment of the present disclosure, the network device 101 indicates the UE behavior(s) of the UE 102 after being woken up by the indication information sent, so that the UE 102 may obtain and perform the relevant UE behavior(s) timely after receiving the indication information, thereby better meeting the demand of the network device 101 and improving the communication efficiency.

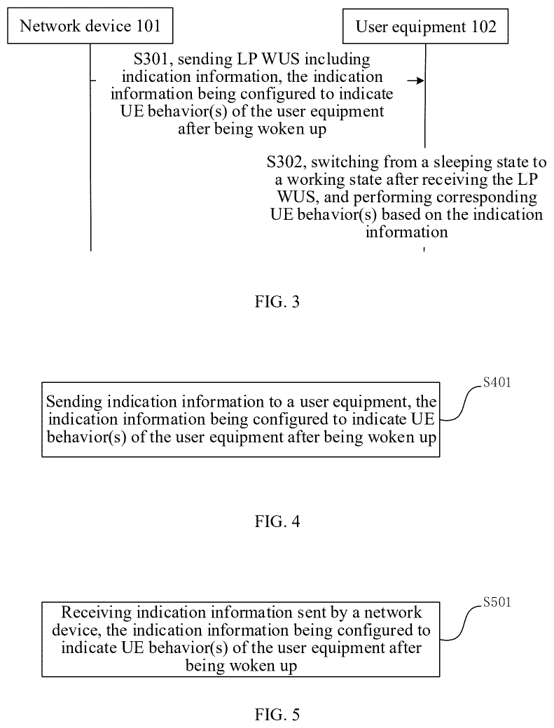

An embodiment of the present disclosure provides a method for transmitting indication information. FIG. 3 shows a method for transmitting indication information according to an embodiment, and as shown in FIG. 3, the method includes steps S301˜S302, specifically:
in step S301, the network device 101 sends a low power wake up signal (LP WUS) to the user equipment (UE) 102, the LP WUS including the indication information, and the indication information being configured to indicate UE behavior(s) of the UE after being woken up; and
in step S302, the UE 102 switches from a sleeping state to a working state after receiving the LP WUS, and performs the corresponding UE behavior(s) according to the indication information.

In some possible implementations, the network device 101 carries the indication information in the LP WUS sent.

In some possible implementations, the LP WUS includes a bit for indicating the UE behavior(s).

In an example, 2 bits in the LP WUS are configured to indicate the UE behavior(s). For example, a value of 00 for the 2 bits corresponds to a first UE behavior, a value of 01 for the 2 bits corresponds to a second UE behavior, a value of 11 for the 2 bits corresponds to a third UE behavior, and a value of 10 for the 2 bits corresponds to a fourth UE behavior.

In some possible implementations, the corresponding UE behavior(s) is indicated by a frequency domain location of the LP WUS. For example, when the LP WUS corresponds to different frequency domain locations, it may correspondingly indicate different UE behaviors.

In some possible implementations, the UE behavior(s) includes one of:
monitoring a paging message;
monitoring system information (SI);
performing a mobility measurement; or
performing a cell reselection.

In an example, when 2 bits in the LP WUS are configured to indicate the UE behavior(s), each value of the 2 bits may correspond to one of the above UE behaviors. For example, when the value of the 2 bits is 00, a first UE behavior corresponding thereto is to monitor the paging message.

In some possible implementations, after the UE 102 receives the LP WUS, the main receiver of the UE 102 may be woken up and enter into the working state from the sleeping state, and the UE behavior(s) indicated by the LP WUS is performed.

In an example, when the UE behavior(s) indicated correspondingly by the LP WUS is to monitor the paging message, the main receiver of the UE 102 is woken up and monitors a paging channel (PCH) in the working state to obtain the paging message timely.

In the embodiment of the present disclosure, the network device 101 carries the indication information in the LP WUS sent, so that the UE 102 may obtain the behavior(s) after being woken up when it receives the wake up signal, and thus the UE 102 may perform the corresponding behavior(s) timely after being woken up, thereby improving the communication efficiency.

An embodiment of the present disclosure provides a method for sending indication information, which is executed by the network device 101. FIG. 4 shows a method for sending indication information according to an embodiment, and as shown in FIG. 4, the method includes step S401, specifically:
in step S401, the network device 101 sends the indication information to the user equipment (UE) 102, the indication information being configured to indicate UE behavior(s) of the UE after being woken up.

In some possible implementations, the network device 101 may wake up the UE 102 by sending an LP WUS.

In some possible implementations, the network device 101 sends the LP WUS and the indication information separately.

In an example, the indication information is sent via signaling other than the LP WUS. For example, the network device 101 sends DCI carrying the indication information to the UE 102.

In some possible implementations, the network device 101 sends the LP WUS and the indication information at the same time.

In an example, the indication information is sent via the LP WUS. For example, the network device 101 sends the LP WUS carrying the indication information to the UE 102.

In some possible implementations, the UE behavior(s) indicated in the indication information may include monitoring a paging message, or a mobility measurement.

In the embodiment of the present disclosure, the network device 101 indicates the UE behavior(s) of the UE 102 after being woken up by the indication information sent, so that the UE 102 may obtain and perform the relevant UE behavior(s) timely after receiving the indication information, thereby better meeting the demand of the network device 101 and improving the communication efficiency.

An embodiment of the present disclosure provides a method for sending indication information, which is executed by the network device 101. The method includes step S401-1, specifically:
in step S401-1, the network device 101 sends a low power wake up signal (LP WUS) to the user equipment (UE) 102, the LP WUS including the indication information and the indication information being configured to indicate UE behavior(s) of the UE 102 after being woken up.

In some possible implementations, the LP WUS sent by the network device 101 includes a bit for indicating the UE behavior(s).

In an example, 2 bits in the LP WUS are configured to indicate the UE behavior(s). For example, a value of 00 for the 2 bits corresponds to a first UE behavior, a value of 01 for the 2 bits corresponds to a second UE behavior, a value of 11 for the 2 bits corresponds to a third UE behavior, and a value of 10 for the 2 bits corresponds to a fourth UE behavior.

In an example, the first UE behavior is, for example, to monitor a paging message, the second UE behavior is, for example, to monitor system information, the third UE behavior is, for example, to perform a mobility measurement, and the fourth UE behavior is, for example, to perform a cell reselection.

In some possible implementations, the method includes step S401-2, specifically:
in step S401-2, the network device 101 sends the LP WUS to the UE 102, a frequency domain location or a time domain location of the LP WUS corresponding to the indication information.

In an implementation, the corresponding UE behavior(s) is indicated by the frequency domain location where the LP WUS is located. For example, when the LP WUS corresponds to different frequency domain locations, different UE behaviors may be correspondingly indicated.

In an example, the bandwidth where the LP WUS is located includes a plurality of resource blocks (RBs), a first RB of the plurality of RBs corresponds to a first UE behavior, a second RB thereof corresponds to a second UE behavior, a third RB thereof corresponds to a third UE behavior, and a fourth RB thereof corresponds to a fourth UE behavior.

In an example, the bandwidth where the LP WUS is located includes 100 RBs, with the first RB being RB0, the second RB being RB20, the third RB being RB40, and the fourth RB being RB60. For example, when the LP WUS is carried at RB0, it indicates that the indicated UE behavior is the first UE behavior.

In an example, the first UE behavior is, for example, to monitor a paging message, the second UE behavior is, for example, to monitor system information, the third UE behavior is, for example, to perform a mobility measurement, and the fourth UE behavior is, for example, to perform a cell reselection.

In some possible implementations, the time domain location of the LP WUS corresponds to the indication information, i.e., the corresponding UE behavior(s) is indicated by the time domain location of the LP WUS.

In an example, the network device 101 may pre-configure time domain resources of the LP WUS for different UE behaviors. For example, the network device 101 configures a period and a start offset of the LP WUS, with each set of period and start offset corresponding to UE behavior(s). In this example, the low power receiver of the UE 102 may be synchronized with the network device 101.

In an example, a first set of time domain resources of the LP WUS includes a period T1 and a start offset offset1, and corresponds to a first UE behavior. A second set of time domain resources includes a period T2 and a start offset offset2, and corresponds to a second UE behavior. A third set of time domain resources includes a period T3 and a start offset offset3, and corresponds to a third UE behavior. A fourth set of time domain resources includes a period T4 and a start offset offset4, and corresponds to a fourth UE behavior.

In an example, the first UE behavior is, for example, to monitor a paging message, the second UE behavior is, for example, to monitor system information, the third UE behavior is, for example, to perform a mobility measurement, and the fourth UE behavior is, for example, to perform a cell reselection.

In some possible implementations, the method includes step S401-3, specifically:
in step S401-3, the network device 101 sends an LP WUS to the user equipment (UE) 102, a cyclic shift value of the LP WUS corresponding to the indication information.

In an implementation, corresponding UE behavior(s) is indicated by the cyclic shift of the LP WUS. For example, the LP WUS is a Zadoff-Chu (ZC) sequence, and a different cyclic shift of the LP WUS correspondingly indicates a different UE behavior.

In an example, a cyclic shift value of P1 for the LP WUS corresponds to a first UE behavior. A cyclic shift value of P2 corresponds to a second UE behavior. A cyclic shift value of P3 corresponds to a third UE behavior. A cyclic shift value of P4 corresponds to a fourth UE behavior.

In an example, the first UE behavior is, for example, to monitor a paging message, the second UE behavior is, for example, to monitor system information, the third UE behavior is, for example, to perform a mobility measurement, and the fourth UE behavior is, for example, to perform a cell reselection.

In some possible implementations, before sending the LP WUS, the network device 101 may send configuration information of the LP WUS.

In an example, the configuration information of the LP WUS is included in the system information.

In some possible implementations, the network device 101 may send the configuration information of the LP WUS in a broadcast or unicast manner.

In an example, the network device 101 sends the configuration information of the LP WUS in the broadcast manner. After receiving the configuration information of the LP WUS, the UE 102 may receive the LP WUS at a suitable time-frequency location in conjunction with a time-frequency resource configuration corresponding to the configuration information.

In an example, the UE 102 that receives the configuration information of the LP WUS may be in a Radio Resource Control (RRC) connected state or in an RRC idle state or in an RRC inactive state.

In an example, the network device 101 sends the configuration information of the LP WUS in the unicast manner. Upon receiving the configuration information of the LP WUS, the UE 102 may receive the LP WUS at a suitable time-frequency location in conjunction with the time-frequency resource configuration corresponding to the configuration information. In an example, the UE 102 that receives the configuration information of the LP WUS is in an RRC connected state.

In the embodiment of the present disclosure, the network device 101 carries the indication information in the LP WUS sent, so that the UE 102 may obtain the behavior(s) after being woken up when it receives the wake up signal, and thus the UE 102 may perform the corresponding behavior(s) timely after being woken up.

An embodiment of the present disclosure provides a method for sending indication information, which is executed by the network device 101.

The method includes step S401, specifically:
in step S401, the network device 101 sends the indication information to the user equipment (UE) 102, the indication information being configured to indicate UE behavior(s) of the UE after being woken up.

Alternatively, the method includes one of steps S401-1 to S401-3.

The UE behavior(s) includes one of:
monitoring a paging message;
monitoring system information;
performing a mobility measurement; or
performing a cell reselection.

In some possible implementations, the UE 102 monitors the paging message carried by a paging channel (PCH).

For example, the UE 102 monitor paging DCI, which is configured to schedule the paging message. After receiving the paging DCI, the UE 102 may detect a paging Physical Downlink Shared channel (paging PDSCH) scheduled by the paging DCI to receive the paging message carried by the paging PDSCH.

In some possible implementations, the UE 102 monitors the system information carried by the PDSCH.

In some possible implementations, the system information includes one of:
system information related to resource configuration of the LP WUS; or
system information related to resource configuration of the paging message.

In an example, in conjunction with the description of the preceding embodiments, the network device 101 may send the system information carrying the configuration information of the LP WUS in the broadcast or unicast manner. The configuration information of the LP WUS may include at least one of a time domain resource configuration, a frequency domain resource configuration, or a power configuration of the LP WUS.

In an example, based on the indication information of the network device 101, the UE 102 monitors the system information related to the configuration information of the LP WUS to obtain the time-frequency configuration of the LP WUS, so as to achieve accurate reception of the LP WUS corresponding to the configuration information of the LP WUS.

In an example, the network device 101 sends the system information carrying the configuration information of the paging message to indicate the resource configuration of the paging message.

In an example, based on the indication information of the network device 101, the UE 102 monitors the system information related to the configuration information of the paging message to receive the paging message corresponding to the configuration information of the paging message at a suitable time-frequency location.

In some possible implementations, the system information related to the resource configuration of the LP WUS includes at least one of:
a first type of system information; or
a second type of system information,
wherein the first type of system information includes an updated time domain resource configuration and/or an updated frequency domain resource configuration of the LP WUS, and the second type of system information includes an updated power configuration of the LP WUS.

In an example, in a scenario where the network device 101 changes the resource configuration of the LP WUS, the network device 101 may send system information including new configuration information of the LP WUS, and the new configuration information of the LP WUS indicates an updated time-frequency configuration of the LP WUS or an updated power configuration.

In an example, the network device 101 may indicate the UE 102 to monitor the first type of system information and the second type of system information after the UE 102 is woken up. After being woken up, the UE 102 monitors the first type of system information and the second type of system information to timely obtain the updated resource configuration of the LP WUS and to accurately receive the new LP WUS based on the updated resource configuration of the LP WUS.

In the scenario where the network device 101 changes the resource configuration of the LP WUS, this example may avoid the problem of the network device 101 not notifying the UE 102 of the updated resource configuration of the LP WUS, which results in the UE 102 not receiving the LP WUS.

In some possible implementations, the system information related to the resource configuration of the paging message includes:
a third type of system information including an updated resource configuration of the paging message.

In an example, in a scenario where the network device 101 changes the resource configuration of the paging message, the network device 101 may send system information including new configuration information of the paging message, and the new configuration information of the paging message indicates an updated time-frequency configuration of the paging message.

In an example, the network device 101 may indicate the UE 102 to monitor the third type of system information after the UE 102 is woken up. After being woken up, the UE 102 monitors the third type of system information to timely obtain the updated resource configuration of the paging message and to accurately receive the paging message based on the updated resource configuration. For example, the paging message is received on the changed paging channel.

In the scenario where the network device 101 changes the resource configuration of the paging message, this example may avoid the problem of the network device 101 not notifying the UE 102 of the changing of the paging channel, which results in the UE 102 still monitoring the old paging channel and thus not receiving the paging message.

In some possible implementations, based on indication of the network device 101, the UE 102 may measure a reference signal of a neighbor cell when performing a mobility measurement or a cell reselection.

In an example, the UE 102 may measure Reference Signal Received Power (RSRP), Reference Signal Received Quality (RSRQ), or Signal to Interference plus Noise Ratio (SINR) of the reference signal of the neighbor cell, and report the measurement result to the network device 101.

In the embodiment of the present disclosure, the network device 101 wakes up the UE 102 using the LP WUS according to the demand thereof, and may indicate, to the UE 102, the UE behavior(s) to be performed after being woken up via the indication information, so that the UE 102 may respond to the demand of the network device 101 timely. For example, if the network device 101 indicates the UE 102 to monitor the paging message, the UE 102 may monitor the paging channel immediately after being woken up. Alternatively, if the network device 101 indicates the UE 102 to monitor the system information, the UE 102 may monitor the changed system information immediately after being woken up. As a further example, if the network device 101 indicates the UE 102 to perform the mobility measurement, the UE 102 may perform the mobility measurement immediately after being woken up and may reselect to another cell to enable the network device 101 to turn off energy saving.

An embodiment of the present disclosure provides a method for receiving indication information, which is performed by the UE 102. FIG. 5 shows a method for receiving indication information according to an embodiment, as shown in FIG. 5, the method includes step S501, specifically:
in step S501, the UE 102 receives the indication information sent by the network device 102, the indication information being configured to indicate UE behavior(s) of the UE after being woken up.

In some possible implementations, the UE 102 may be woken up after receiving an LP WUS of the network device 101. The waking up means that the main receiver of the UE 102 is switched from the sleeping state to the working state to perform operations such as sending and receiving of data.

In an example, when the UE 102 receives the LP WUS, the main receiver of the UE 102 is woken up and enters into the working state, the UE behavior(s) indicated by the indication information is performed.

In some possible implementations, before the UE 102 receives the LP WUS, the main receiver is in a sleeping state, and the UE 102 employs a separate low-power receiver to monitor and receive the LP WUS.

In the embodiment of the present disclosure, the UE 102 may timely obtain the UE behavior(s) after being woken up through the indication information sent by the network device 101, so that the UE 102 may perform the relevant behavior(s) timely, thereby better meeting the demand of the network device and improving the communication efficiency.

An embodiment of the present disclosure provides a method for receiving indication information, which is executed by the UE 102. The method includes step S501-1, specifically:
in step S501-1, the UE 102 receives a low power wake up signal (LP WUS) sent by the network device 101, the LP WUS including the indication information, and the indication information being configured to indicate UE behavior(s) of the UE after being woken up.

In some possible implementations, the network device 101 carries the indication information in the LP WUS sent.

In some possible implementations, the LP WUS sent by the network device 101 includes a bit for indicating the UE behavior(s). For example, 2 bits in the LP WUS are configured to indicate the UE behavior(s). Different values of the 2 bits correspond to different UE behaviors.

In some possible implementations, the method includes step S501-2, specifically:
in step S501-2, the UE 102 receives the LP WUS sent by the network device 101, and determines the indication information based on a frequency domain location or a time domain location of the LP WUS.

In an implementation, corresponding UE behavior(s) may be indicated by the frequency domain location of the LP WUS. For example, when the LP WUS corresponds to different frequency domain locations, it may correspondingly indicate different UE behaviors.

In an example, the bandwidth where the LP WUS is located includes a plurality of RBs, a first RB of the plurality of RBs corresponds to a first UE behavior, a second RB thereof corresponds to a second UE behavior, a third RB thereof corresponds to a third UE behavior, and a fourth RB thereof corresponds to a fourth UE behavior.

In an example, the bandwidth where the LP WUS is located includes 100 RBs, with the first RB being RB0, the second RB being RB20, the third RB being RB40, and the fourth RB being RB60. For example, when the LP WUS is carried at RB0, it indicates that the indicated UE behavior is the first UE behavior.

In an example, the first UE behavior is, for example, to monitor a paging message, the second UE behavior is, for example, to monitor system information, the third UE behavior is, for example, to perform a mobility measurement, and the fourth UE behavior is, for example, to perform a cell reselection.

In an implementation, the corresponding UE behavior(s) may also be indicated by the time domain location of the LP WUS.

In an example, the network device 101 may pre-configure time domain resources of the LP WUS for different UE behaviors. For example, the network device 101 configures a period and a start offset of the LP WUS, with each set of period and start offset corresponding to UE behavior(s). In this example, the low power receiver of the UE 102 may be synchronized with the network device 101.

In an example, a first set of time domain resources of the LP WUS includes a period T1 and a start offset offset1, and corresponds to a first UE behavior. A second set of time domain resources includes a period T2 and a start offset offset2, and corresponds to a second UE behavior. A third set of time domain resources includes a period T3 and a start offset offset3, and corresponds to a third UE behavior. A fourth set of time domain resources includes a period T4 and a start offset offset4, and corresponds to a fourth UE behavior.

In an example, the first UE behavior is, for example, to monitor a paging message, the second UE behavior is, for example, to monitor system information, the third UE behavior is, for example, to perform a mobility measurement, and the fourth UE behavior is, for example, to perform a cell reselection.

In some possible implementations, the method includes step S501-3, specifically:
in step S501-3, the UE 102 receives the LP WUS sent by the network device 101 and determines the indication information based on a cyclic shift value of the LP WUS.

In an implementation, corresponding UE behavior(s) is indicated by the cyclic shift of the LP WUS. For example, the LP WUS is a Zadoff-Chu (ZC) sequence, and a different cyclic shift of the LP WUS correspondingly indicates a different UE behavior.

In an example, a cyclic shift value of P1 for the LP WUS corresponds to a first UE behavior. A cyclic shift value of P2 corresponds to a second UE behavior. A cyclic shift value of P3 corresponds to a third UE behavior. A cyclic shift value of P4 corresponds to a fourth UE behavior.

In an example, the first UE behavior is, for example, to monitor a paging message, the second UE behavior is, for example, to monitor system information, the third UE behavior is, for example, to perform a mobility measurement, and the fourth UE behavior is, for example, to perform a cell reselection.

In some possible implementations, each LP WUS may correspondingly have configuration information of the LP WUS. Before receiving the corresponding LP WUS, the UE 102 may first receive the configuration information of the LP WUS sent by the network device 101 so as to receive the LP WUS at an appropriate time-frequency resource.

In the embodiment of the present disclosure, after receiving the LP WUS, the UE 102 may be woken up based on the LP WUS and obtain the indication information therein.

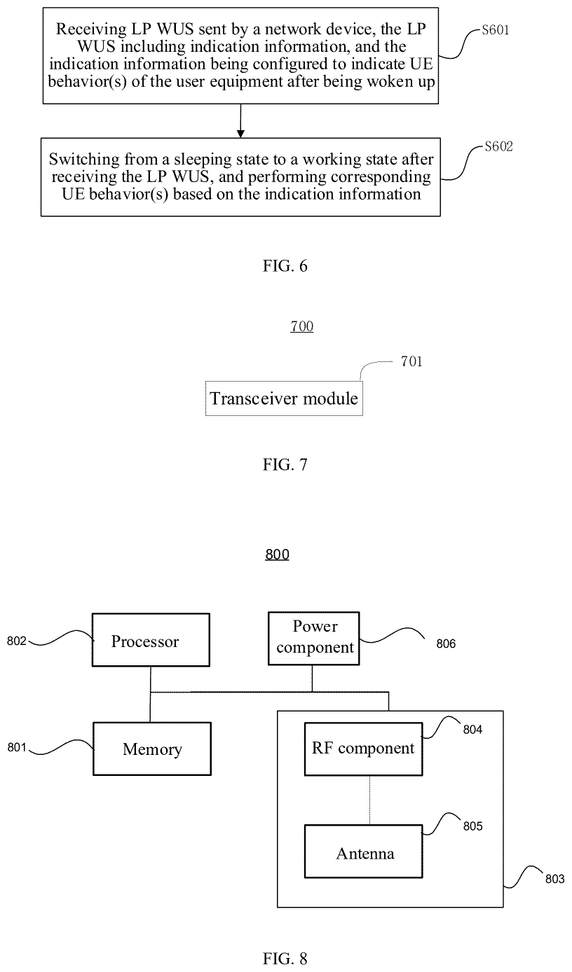

An embodiment of the present disclosure provides a method for receiving indication information, which is executed by the UE 102. FIG. 6 shows a method for receiving indication information according to an embodiment, and as shown in FIG. 6, the method includes steps S601˜S602, specifically:
in step S601, the UE 102 receives a low power wake up signal (LP WUS) sent by the network device 101, the LP WUS including the indication information and the indication information being configured to indicate UE behavior(s) of the UE after being woken up; and
in step S602, the UE 102 is switched from a sleeping state to a working state after receiving the LP WUS, and performs corresponding UE behavior(s) based on the indication information.

In some possible implementations, the UE behavior(s) includes one of:
monitoring a paging message;
monitoring system information;
performing a mobility measurement; or
performing a cell reselection.

In some possible implementations, the UE 102 monitors the paging message carried by a paging channel (PCH).

For example, the UE 102 monitors paging DCI, which is configured to a paging event. After receiving the paging DCI, the UE 102 may detect a paging Physical Downlink Shared channel (paging PDSCH) scheduled by the paging DCI to receive the paging message carried by the paging PDSCH.

In some possible implementations, the UE 102 monitors the system information carried by the PDSCH.

In some possible implementations, the system information includes one of:
system information related to resource configuration of the LP WUS; or
system information related to resource configuration of the paging message.

In some possible implementations, the system information related to the resource configuration of the LP WUS includes at least one of:
a first type of system information; or
a second type of system information,
wherein the first type of system information includes an updated time domain resource configuration and/or an updated frequency domain resource configuration of the LP WUS, and the second type of system information includes an updated power configuration of the LP WUS.

In some possible implementations, performing the corresponding UE behavior(s) based on the indication information in step S602 may include steps S602-11 to S602-12 as follows, specifically:
in step S602-11, the UE 102 receives the first type of system information or the second type of system information when the indication information corresponds to monitoring of the system information related to the resource configuration of the LP WUS; and
in step S602-12, according to the first type of system information or the second type of system information, the UE 102 monitors the LP WUS based on the updated resource configuration of the LP WUS.

In an example, based on the indication information, after being woken up, the UE 102 monitors the first type of system information and the second type of system information to timely obtain the updated resource configuration of the LP WUS and to accurately receive the new LP WUS based on the updated resource configuration of the LP WUS.

In some possible implementations, the system information related to the resource configuration of the paging message includes:
a third type of system information including an updated resource configuration of the paging message.

In some possible implementations, performing the corresponding UE behavior(s) based on the indication information in step S602 may include steps S602-21˜S602-22 as follows, specifically:
in step S602-21, the UE 102 receives the third type of system information when the indication information corresponds to monitoring of the system information related to the resource configuration of the paging message; and
in step S602-22, according to the third type of system information, the UE 102 monitors the paging message based on an updated resource configuration of the paging message.

In an example, based on the indication information, after being woken up, the UE 102 monitors the third type of system information to timely obtain the updated resource configuration of the paging message and to accurately receive the paging message based on the updated resource configuration. For example, the paging message is received on the changed paging channel.

In the embodiment of the present disclosure, the UE 102 may perform corresponding UE behavior(s) based on the indication information of the network device 101, so that the UE 102 may timely obtain the changed relevant configuration of the network device 101, and thus may receive the relevant paging message or system information at an accurate time domain location even after the change has occurred.

Based on the same concept as the above method embodiments, an embodiment of the present disclosure also provides a device for sending indication information, which may have the function of the network device 101 in the above method embodiments and may be configured to perform the steps performed by the network device 101 provided by the above method embodiments. The function may be implemented by hardware, or by software, or by hardware executing corresponding software. The hardware or software includes one or more modules corresponding to the function described above.

In a possible implementation, the device 700 as shown in FIG. 7 may act as the network device 101 involved in the above method embodiments and perform the steps performed by the network device 101 in the above method embodiments. As shown in FIG. 7, the device 700 may include a transceiver module 701. The transceiver module 701 may be configured to support communication of a communication device, and the transceiver module 701 may have a wireless communication function, for example, to communicate wirelessly with another communication device via wireless radio.

When performing the steps implemented by the network device 101, the transceiver module 701 is configured to send indication information to a user equipment (UE), the indication information being configured to indicate UE behavior(s) of the UE after being woken up.

In some possible implementations, the transceiver module 701 is further configured to sending a low power wake up signal (LP WUS) to the UE, the LP WUS including the indication information.

In some possible implementations, the transceiver module 701 is further configured to send an LP WUS to the UE, a frequency domain location or a time domain location of the LP WUS corresponding to the indication information.

In some possible implementations, the transceiver module 701 is further configured to send an LP WUS to the UE, a cyclic shift value of the LP WUS corresponding to the indication information.

In some possible implementations, the UE behavior(s) includes one of:
monitoring a paging message;
monitoring system information;
performing a mobility measurement; or
performing a cell reselection.

In some possible implementations, the system information includes one of:
system information related to resource configuration of the LP WUS; or
system information related to resource configuration of the paging message.

In some possible implementations, the system information related to the resource configuration of the LP WUS includes at least one of:
a first type of system information; or
a second type of system information,
wherein the first type of system information includes an updated time domain resource configuration and/or an updated frequency domain resource configuration of the LP WUS, and the second type of system information includes an updated power configuration of the LP WUS.

In some possible implementations, the system information related to the resource configuration of the paging message includes:
a third type of system information including an updated resource configuration of the paging message.

When the communication device is the network device 101, the structure thereof may also be shown in FIG. 8. The structure of the communication device is illustrated by using a base station as an example. As shown in FIG. 8, the device 800 includes a memory 801, a processor 802, a transceiver component 803, and a power component 806. The memory 801 is coupled to the processor 802 and may be used to store programs and data necessary for the communication device 800 to implement various functions. The processor 802 is configured to support the communication device 800 to perform the corresponding functions in the method described above, and the functions may be realized by calling programs stored in the memory 801. The transceiver component 803 may be a wireless transceiver that may be used to support the communication device 800 to receive signal and/or data and send signal and/or data via a wireless radio. The transceiver component 803 may also be referred to as a transceiver unit or a communication unit. The transceiver component 803 may include a radio frequency (RF) component 804 and one or more antennas 805. The RF component 804 may be a remote radio unit (RRU), which may be specifically used for the transmission of RF signals and the conversion between RF signals and baseband signals. The one or more antennas 805 may be used specifically for radiation and reception of RF signals.

When the communication device 800 needs to send data, the processor 802 may perform baseband processing on the data to be sent and then output a baseband signal to a RF unit. The RF unit performs RF processing on the baseband signal, and then transmits a RF signal in the form of electromagnetic waves through the antenna. When there is data sent to the communication device 800, the RF unit receives the RF signal through the antenna, converts the RF signal into a baseband signal, and outputs the baseband signal to the processor 802, which converts the baseband signal into data and processes the data.

Based on the same concept as the above method embodiments, an embodiment of the present disclosure also provides a device for receiving indication information that may have the function of the user equipment 102 in the above method embodiments and may be used to perform the steps performed by the user equipment 102 provided by the above method embodiments. The function may be implemented by hardware, or by software, or by hardware executing corresponding software. The hardware or software includes one or more modules corresponding to the function described above.

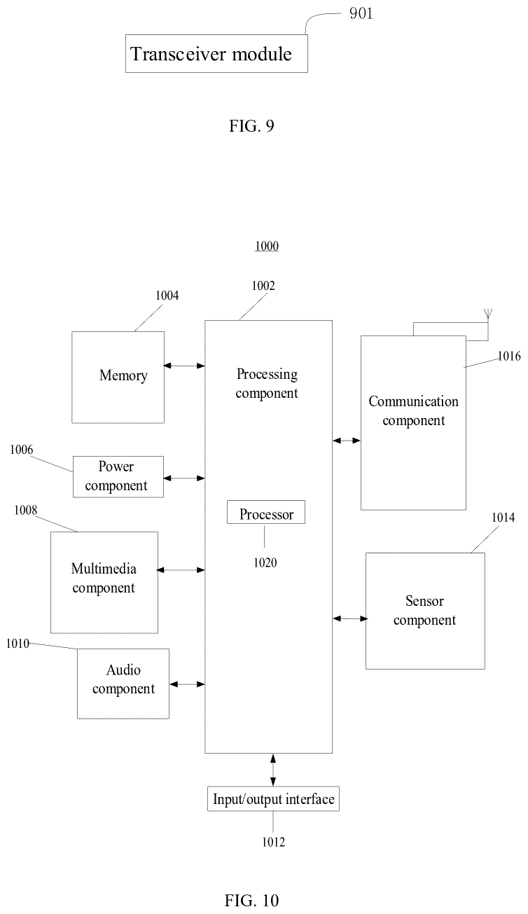

In a possible implementation, the device 900 as shown in FIG. 9 may act as the user equipment 102 involved in the above method embodiments and perform the steps performed by the user equipment 102 in the above method embodiments. As shown in FIG. 9, the communication device 900 may include a transceiver module 901, and the transceiver module 901 may support communication of the communication device. The transceiver module 901 may have a wireless communication function, for example, it may communicate wirelessly with other communication devices via wireless radio.

When performing the steps performed by the user equipment 102, the transceiver module 901 is configured to receive the indication information sent by a network device, the indication information being configured to indicate UE behavior(s) of the UE after being woken up.

In some possible implementations, the transceiver module 901 is further configured to receive a low power wake up signal (LP WUS) sent by the network device, the LP WUS including the indication information.

In some possible implementations, the transceiver module 901 is further configured to receive an LP WUS sent by the network device; and
the device 900 further includes a processing module coupled to the transceiver module 901, wherein the processing module is configured to determine the indication information based on a frequency domain location or a time domain location of the LP WUS.

In some possible implementations, the transceiver module 901 is further configured to receive an LP WUS sent by the network device; and
the processing module is further configured to determining the indication information based on a cyclic shift value of the LP WUS.

In some possible implementations, the UE behavior(s) includes one of:
monitoring a paging message;
monitoring system information;
performing a mobility measurement; or
performing a cell reselection.

In some possible implementations, the processing module is further configured to switch from a sleeping state to a working state after receiving the LP WUS, and perform corresponding UE behavior(s) based on the indication information.

In some possible implementations, the transceiver module 901 is further configured to receive a first type of system information or a second type of system information when the indication information corresponds to monitoring of system information related to resource configuration of the LP WUS; and
the processing module is further configured to, according to the first type of system information or the second type of system information, monitor the LP WUS based on an updated resource configuration of the LP WUS.

In some possible implementations, the transceiver module 901 is further configured to receive a third type of system information when the indication information corresponds to monitoring of system information related to resource configuration of the paging message; and
the processing module is further configured to, according to the third type of system information, monitor the paging message based on an updated resource configuration of the paging message.

When the device for receiving indication information is the user equipment 102, the structure thereof may also be as shown in FIG. 10. The device 1000 may be a mobile phone, a computer, a digital broadcasting terminal, a message transceiver device, a gaming console, a tablet device, a medical device, a fitness device, a personal digital assistant, and the like.

Referring to FIG. 10, the device 1000 may include one or more of a processing component 1002, a memory 1004, a power component 1006, a multimedia component 1008, an audio component 1010, an input/output (I/O) interface 1012, a sensor component 1014, and a communication component 1016.

The processing component 1002 generally controls the overall operations of the device 1000, such as operations associated with display, telephone calls, data communications, camera operations, and recording operations. The processing component 1002 may include one or more processors 1020 to execute instructions to complete all or part of the steps of the foregoing method. In addition, the processing component 1002 may include one or more modules to facilitate interaction between the processing component 1002 and other components. For example, the processing component 1002 may include a multimedia module to facilitate the interaction between the multimedia component 1008 and the processing component 1002.

The memory 1004 is configured to store various types of data to support the operation at the device 1000. Examples of these data include instructions for any application or method operating on the device 1000, contact data, phone book data, messages, pictures, videos and the like. The memory 1004 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 1006 provides power to various components of the device 1000. The power component 1006 may include a power management system, one or more power supplies, and other components associated with generating, managing, and distributing power for the device 1000.

The multimedia component 1008 includes a screen that provides an output interface between the device 1000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 1008 includes a front camera and/or a rear camera. When the device 1000 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 1010 is configured to output and/or input audio signals. For example, the audio component 1010 includes a microphone (MIC), and when the device 1000 is in an operation mode, such as a call mode, a recording mode, and a voice recognition mode, the microphone is configured to receive an external audio signal. The received audio signal can be further stored in the memory 1004 or sent via the communication component 1016. In some embodiments, the audio component 1010 further includes a speaker for outputting audio signals.

The I/O interface 1012 provides an interface between the processing component 1002 and a peripheral interface module. The above-mentioned peripheral interface module may be a keyboard, a click wheel, a button, and the like. These buttons may include but are not limited to home button, volume button, start button, and lock button.

The sensor component 1014 includes one or more sensors for providing the device 1000 with various aspects of state evaluation. For example, the sensor component 1014 can detect the on/off status of the device 1000 and the relative positioning of components. For example, the component is a display and keypad of the device 1000. The sensor component 1014 can also detect the position change of the device 1000 or a component of the device 1000, the presence or absence of contact between the user and the device 1000, the orientation or acceleration/deceleration of the device 1000, and the temperature change of the device 1000. The sensor component 1014 may include a proximity sensor configured to detect the presence of nearby objects when there is no physical contact. The sensor component 1014 may also include a light sensor, such as a CMOS or CCD image sensor, for use in imaging applications. In some embodiments, the sensor component 1014 may also include an acceleration sensor, a gyroscope sensor, a magnetic sensor, a pressure sensor, or a temperature sensor.

The communication component 1016 is configured to facilitate wired or wireless communication between the device 1000 and other devices. The device 1000 can access a wireless network based on a communication standard, such as WiFi, 2G, 3G, 4G or 5G, or a combination thereof. In an embodiment, the communication component 1016 receives a broadcast signal or broadcast related information from an external broadcast management system via a broadcast channel. In an embodiment, the communication component 1016 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 1000 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 1004 including instructions, and the instructions may be executed by the processor 1020 of the device 1000 to complete the foregoing method. For example, the non-transitory computer-readable storage medium may be ROM, random access memory (RAM), CD-ROM, magnetic tape, floppy disk, optical data storage device and the like.

A person skilled in the art may easily conceive of other implementations of the embodiments of the present disclosure upon consideration of the specification and practice of the invention disclosed herein. The present disclosure is intended to cover any variations, uses, or adaptations of the embodiments of the present disclosure that follow the general principle of the embodiments of the present disclosure and include the common knowledge or conventional technical means in the technical field not disclosed by the present disclosure. The specification and embodiments are to be regarded as exemplary only, with the true scope and spirit of the present disclosure being indicated by the following claims.

It is to be understood that the embodiments of the present disclosure are not limited to the precise structures described above and illustrated in the accompanying drawings, and that various modifications and changes may be made without departing from the scope thereof. The scope of the embodiments of the present disclosure is limited only by the appended claims.

In the method of the present disclosure, the network device indicates the UE behavior(s) of the UE after being woken up by the indication information sent, so that the UE may obtain and perform the relevant UE behavior(s) timely after receiving the indication information, thereby better meeting the demand of the network device and improving the communication efficiency.

1. A method for sending indication information, being performed by a network device, and comprising:
sending the indication information to a user equipment (UE), wherein the indication information is configured to indicate UE behavior(s) of the UE after being woken up.

2. The method according to claim 1, wherein sending the indication information to the UE comprises:
sending a low power wake up signal (LP WUS) to the UE, wherein the LP WUS comprises the indication information.

3. The method according to claim 1, wherein sending the indication information to the UE comprises:
sending an LP WUS to the UE, wherein a frequency domain location or a time domain location of the LP WUS corresponds to the indication information.

4. The method according to claim 1, wherein sending the indication information to the UE comprises:
sending an LP WUS to the UE, wherein a cyclic shift value of the LP WUS corresponds to the indication information.

5. The method according to claim 1, wherein sending the indication information to the UE comprises:
sending an LP WUS to the UE, wherein the LP WUS comprises or indicates the indication information,
wherein the UE behavior(s) comprises one of:
monitoring a paging message;
monitoring system information;
performing a mobility measurement; or
performing a cell reselection.

6. The method according to claim 5, wherein the system information comprises one of:
system information related to resource configuration of the LP WUS; or
system information related to resource configuration of the paging message.

7. The method according to claim 6, wherein the system information related to the resource configuration of the LP WUS comprises at least one of:
a first type of system information; or
a second type of system information,
wherein the first type of system information comprises at least one of an updated time domain resource configuration or an updated frequency domain resource configuration of the LP WUS, and the second type of system information comprises an updated power configuration of the LP WUS.

8. The method according to claim 6, wherein the system information related to the resource configuration of the paging message comprises:
a third type of system information comprising an updated resource configuration of the paging message.

9. A method for receiving indication information, being performed by a user equipment (UE), and comprising:
receiving the indication information sent by a network device, wherein the indication information is configured to indicate UE behavior(s) of the UE after being woken up.

10. The method according to claim 9, wherein receiving the indication information sent by the network device comprises:
receiving a low power wake up signal (LP WUS) sent by the network device, wherein the LP WUS comprises the indication information.

11. The method according to claim 9, wherein receiving the indication information sent by the network device comprises:
receiving an LP WUS sent by the network device; and
determining the indication information based on a frequency domain location or a time domain location of the LP WUS.

12. The method according to claim 9, wherein receiving the indication information sent by the network device comprises:
receiving an LP WUS sent by the network device; and
determining the indication information based on a cyclic shift value of the LP WUS.

13. The method according to claim 9, wherein receiving the indication information sent by the network device comprises:
receiving a low power wake up signal (LP WUS) sent by the network device,
wherein the LP WUS comprises or indicates the indication information,
wherein the UE behavior(s) comprises one of:
monitoring a paging message;
monitoring system information;
performing a mobility measurement; or
performing a cell reselection.

14. The method according to claim 13, further comprising:
switching from a sleeping state to a working state after receiving the LP WUS, and performing corresponding UE behavior(s) based on the indication information.

15. The method according to claim 14, wherein performing the corresponding UE behavior(s) based on the indication information comprises:
receiving a first type of system information or a second type of system information when the indication information corresponds to monitoring of system information related to resource configuration of the LP WUS; and
according to the first type of system information or the second type of system information, monitoring the LP WUS based on an updated resource configuration of the LP WUS.

16. The method according to claim 14, wherein performing the corresponding UE behavior(s) based on the indication information comprises:
receiving a third type of system information when the indication information corresponds to monitoring of system information related to resource configuration of the paging message;
according to the third type of system information, monitoring the paging message based on an updated resource configuration of the paging message.

17-22. (canceled)

23. A network device, comprising:
a processor; and
a memory, having instructions stored thereon that, when being executed by the processor, causes the network device to implement actions comprising:
sending the indication information to a user equipment (UE), wherein the indication information is configured to indicate UE behavior(s) of the UE after being woken up.

24. The network device according to claim 23, wherein sending the indication information to the UE comprises:
sending a low power wake up signal (LP WUS) to the UE, wherein the LP WUS comprises the indication information.

25. The network device according to claim 23, wherein sending the indication information to the UE comprises:
sending an LP WUS to the UE, wherein a frequency domain location or a time domain location of the LP WUS corresponds to the indication information.

26. A user equipment, comprising:
a processor; and
a memory, having instructions stored thereon that, when being executed by the processor, causes the user equipment to implement the method according to claim 9.
